(19) United States
(12) Patent Application Publication
(10) Pub. No.: US 2025/0362994 A1
(43) Pub. Date: Nov. 27, 2025

(54) BLOCKCHAIN-BASED VEHICLE FAULT INFORMATION MANAGEMENT SYSTEM, APPARATUS, AND METHOD

(71) Applicant: HYUNDAI AUTOEVER CORP., Seoul (KR)

(72) Inventors: Dong Jin Jeon, Seoul (KR); Ji Su Kang, Seoul (KR)

(73) Assignee: HYUNDAI AUTOEVER CORP., Seoul (KR)

(21) Appl. No.: 19/215,039

(22) Filed: May 21, 2025

(30) Foreign Application Priority Data
May 23, 2024 (KR) 10-2024-0066888

(51) Int. Cl. G06F 11/07

(52) U.S. Cl. CPC G06F 11/0787; G06F 11/0739

(57) ABSTRACT

A system for managing fault information about vehicles based on blockchain includes a data storage unit configured to store at least one of fault information or a repair history of the vehicles, with interlinked blockchain tokens of vehicle controllers. The system also includes a first data transmission-reception unit configured to transmit and receive, to and from a main server, data pertaining to at least one of the fault information or the repair history of the vehicles, at preset periodic intervals. The main server is configured to classify and manage the data by types of the vehicles. The vehicle controllers each includes a plurality of electronic control units (ECUs) capable of storing the fault information in response to an occurrence of a fault, and a communication module configured to wirelessly communicate with the main server.

### CROSS-REFERENCE TO RELATED APPLICATION

This application claims the benefit of and priority to Korea Patent Application No. 10-2024-0066888, filed on May 23, 2024, the entire contents of which are hereby incorporated herein by reference.

### FIELD OF TECHNOLOGY

The present disclosure relates to a system, apparatus, and method for managing fault information about vehicles based on blockchain.

### BACKGROUND

In the related art, to obtain vehicle failure diagnosis information, it is necessary to connect a diagnostic device to a physical on-board diagnostics (OBD) terminal. This process means that vehicle owners need to visit a service center with specialists to diagnose and repair failures. Consequently, several problems arise from this process.

First, when a failure has occurred, consumers have to forgo convenience and visit a service center. This means that the consumers have to expend time and money for the failure diagnosis of their vehicles. Particularly, in urgent situations where a vehicle failure is imminent, the consumers may face even greater difficulties.

Moreover, it is difficult for vehicle manufacturers to track and analyze the incidence of vehicle failures and their repair histories. Because existing diagnostic and management methods are implemented only after a failure has already occurred, effectively analyzing data about previous failures is challenging. This increases a likelihood of similar problems recurring, which may, in turn, diminish consumer confidence.

Moreover, preventing vehicle failures proactively is difficult. Because existing vehicle fault diagnosis and management systems primarily involve measures taken after a failure has already occurred, it is difficult to predict or prevent failures proactively. This may negatively affect the safety and performance of vehicles.

In addition, there are issues concerning information security. Because past systems necessitate the external transmission of vehicle data, the systems are vulnerable in the protection of related information. This entails risks of data leakage or malicious use. Moreover, responses to the malicious alteration of related data may be inadequate.

The discussions in this section are intended merely to provide background information and do not constitute an admission of prior art.

### SUMMARY

Embodiments of the present disclosure provide a blockchain-based vehicle fault information management system, apparatus, and method, that store fault information about vehicles based on blockchain and effectively managing the fault information via a main server.

Embodiments of the present disclosure provide a blockchain-based vehicle fault information management system, apparatus, and method, offering enhanced security and increased reliability by assuring data validity through the utilization of blockchain.

Embodiments of the present disclosure provide a blockchain-based vehicle fault information management system, apparatus, and method, that perform data modeling by referencing data from blocks generated for each vehicle type and analyzing fault types specific to each vehicle type.

According to an embodiment, a system for managing fault information about vehicles based on blockchain is provided. The system includes a data storage unit configured to store at least one of fault information or a repair history of the vehicles, with interlinked blockchain tokens of vehicle controllers. The system also includes a first data transmission/reception unit configured to transmit and receive, to and from a main server, data pertaining to at least one of the fault information or the repair history of the vehicles, at preset periodic intervals. The main server is configured to classify and manage the data by types of the vehicles, data pertaining to at least one of the fault information or the repair history of the vehicles. The vehicle controllers each includes a plurality of electronic control units (ECUs) capable of storing the fault information in response to an occurrence of a fault, and a communication module capable of wireless communication with the main server.

The system may further include a second data transmission/reception module configured to transmit the data from the main server to user terminals of the vehicles so as to enable users of the vehicles to monitor data pertaining to at least one of the fault information or the repair history.

In the data storage unit, the blockchain tokens of the vehicle controllers may mutually assure data validity to ensure data security.

The blockchain tokens of the vehicle controllers may be issued via hash values that are generated based on unique numbers of the vehicles when the vehicles are manufactured, respectively.

The ECUs may determine, according to preset criteria, whether data corresponds to the fault information, and manage the data as fault memory.

The first data transmission/reception unit may transmit fault memory data, along with the vehicle information, to the main server by using a wireless communication network.

The main server may, in response to a vehicle being manufactured or in response to data pertaining to at least one of new fault information or repair history being generated, request the blockchain tokens of the vehicle controllers to update hash information.

The blockchain tokens of the vehicle controllers may, in response to an occurrence of a request to update the hash information, request update credential verification from other vehicles that are connected via a wireless communication network through the main server.

In response to a validity assessment result, which is computed in response to the update credential verification request, being determined to satisfy a preset criterion, credential verification may be completed, and the blockchain tokens of the vehicle controllers may perform an update of the hash information.

Execution of the update for which the credential verification has been completed may be given priority by the blockchain tokens of the vehicle controllers.

According to another embodiment, an apparatus for managing fault information about vehicles based on blockchain is provided. The apparatus includes a data storage module configured to store at least one of fault information or a repair history of the vehicles, with interlinked blockchain tokens of vehicle controllers. The apparatus also includes a first data transmission/reception module configured to transmit and receive, to and from a main server configured to classify and manage the data by types of the vehicles, data pertaining to at least one of the fault information or the repair history of the vehicles, at preset periodic intervals. The apparatus additionally includes a second data transmission/reception module configured to transmit the data from the main server to terminals of users of the vehicles so as to enable the users of the vehicles to monitor data pertaining to at least one of the fault information or the repair history. The vehicle controllers each includes a plurality of ECUs capable of storing the fault information in response to an occurrence of a fault, and a communication module capable of wireless communication with the main server.

In the data storage module, the blockchain tokens of the vehicle controllers may mutually assure data validity to ensure data security.

The first data transmission/reception module may collect data pertaining to at least one of the fault information or the repair history of the vehicles by utilizing a Unified Diagnostic Services (UDS) diagnostic protocol.

According to yet another embodiment, a method of managing fault information about vehicles based on blockchain is provided. The method includes a data storage operation of storing at least one of fault information or a repair history of the vehicles, in interlinked blockchain tokens of vehicle controllers. The method also includes a first data transmission/reception operation of transmitting and receiving data pertaining to at least one of the fault information or the repair history of the vehicles at preset periodic intervals. The method additionally includes a data management operation of managing the data by classifying the data in a main server according to types of the vehicles and updating the data with new information. The vehicle controllers each includes a plurality of ECUs capable of storing the fault information in response to an occurrence of a fault, and a communication module capable of wireless communication with the main server.

The method may further include transmitting the data from the main server to terminals of users of the vehicles so as to enable the users of the vehicles to monitor data pertaining to at least one of the fault information or the repair history.

Storing the at least one of the fault information or the repair history of the vehicles may include determining, by the ECUs, whether data corresponds to the fault information, according to preset criteria. and managing data corresponding to the fault information as fault memory.

The ECUs may, while the vehicles are driving, determine whether data corresponds to the fault information, and store the data.

Managing the data may include classifying the data received by the main server according to the types of the vehicles. Managing the data may also include, in response to a vehicle being manufactured or in response to data pertaining to at least one of new fault information or repair history being generated, requesting the blockchain tokens of the vehicle controllers to update hash information. Managing the data may additionally include, in response to an occurrence of a request to update the hash information, requesting, by the blockchain tokens of the vehicle controllers, update credential verification from other vehicles that are connected via a wireless communication network through the main server. Managing the data may further include, in response to completion of update credential verification, performing, by the blockchain tokens of the vehicle controllers, an update of the hash information.

The update credential verification may be completed in response to a validity assessment result, which is computed in response to an update credential verification request, being determined to satisfy a preset criterion.

Execution of the update for which the credential verification has been completed may be given priority by the blockchain tokens of the vehicle controllers.

According to embodiments of the present disclosure, a blockchain-based vehicle fault information management system, apparatus, and method may be provided, which are capable of storing fault information about vehicles based on blockchain and effectively managing the fault information via a main server.

In addition, according to the embodiments of the present disclosure, a blockchain-based vehicle fault information management system, apparatus, and method may be provided, offering enhanced security and increased reliability by assuring data validity through the utilization of blockchain.

Moreover, according to the embodiments of the present disclosure, a blockchain-based vehicle fault information management system, apparatus, and method may be provided, which are capable of performing data modeling by referencing data from blocks generated for each vehicle type and analyzing fault types specific to each vehicle type.

The technical objectives of the present disclosure are not limited to those mentioned above. Other technical objectives not mentioned herein should be more clearly understood by those having ordinary skill in the art from the following description.

### BRIEF DESCRIPTION OF THE DRAWINGS

FIG. 1 is a diagram illustrating a vehicle fault information management system according to an embodiment.

FIG. 2 is a diagram illustrating a vehicle controller according to an embodiment.

FIG. 3 is a schematic diagram illustrating periodic transmission of fault data to a main server while a vehicle is driving.

FIG. 4 is a schematic diagram illustrating management of collected fault data and transmission of the fault data to a user terminal.

FIG. 5 is a schematic diagram illustrating a process in which an electronic control unit (ECU) confirms and stores fault data.

FIG. 6 is a schematic diagram illustrating a process in which a plurality of vehicles perform computations for a credential verification request regarding fault information to determine the validity of the fault information, and perform updates.

FIG. 7 is a schematic diagram illustrating a fault information management process that addresses malicious data alteration.

FIG. 8 is a flowchart illustrating a vehicle fault information management method according to an embodiment.

FIG. 9 is a flowchart illustrating a data storage operation according to an embodiment.

FIG. 10 is a flowchart illustrating a data management operation according to an embodiment.

The drawings described herein are for illustration purposes only and are not intended to limit the scope of the present disclosure in any way.

### DETAILED DESCRIPTION

Hereinafter, some embodiments of the present disclosure are described in detail with reference to accompanying drawings. It should be noted that in assigning reference numerals to components in each drawing, identical components are designated with the same reference numerals whenever possible, even when the components are illustrated in different drawings. Furthermore, in the description of the present disclosure, where it was determined that a detailed description of related known configurations or functions would obscure the gist of the present disclosure, a detailed description thereof has been omitted.

In addition, in describing components of the present disclosure, expressions such as “first”, “second”, “A”, “B”, “(a)”, or “(b)” may be used. These expressions are only intended to distinguish one component from another, and do not limit the nature, order, or sequence of the components. It should be understood that, when it is described that a first element is “connected,” “coupled,” or “joined” to a second element, the first element may be directly connected, coupled, or joined to the second element, or the first element may be connected, coupled, or joined to the second element with a third element connected, coupled, or joined therebetween.

When a component, controller, device, element, apparatus, unit, module or the like of the present disclosure is described as having a purpose or performing an operation, function, or the like, the component, controller, device, element, apparatus, unit, module or the like should be considered herein as being “configured to” meet that purpose or to perform that operation or function. Each component, controller, device, element, apparatus, unit, module and the like may separately embody or be included with a processor and a memory, such as a non-transitory computer readable media, as part of the apparatus.

Blockchain technology offers innovative security, enabling the secure management and transmission of digital data. This blockchain technology establishes robust security against attacks through a decentralized database and encryption techniques, ensuring data integrity and confidentiality. The security of blockchain is enabling innovative applications and trustworthy transactions across diverse industry sectors.

Blockchain technology may offer secure data management through a decentralized database. Unlike traditional centralized databases, blockchain eliminates a single point of attack by storing data in a distributed manner across all nodes participating in a network. This structure may prevent hackers from compromising a single server or database to steal or modify data. Consequently, blockchain offers an enhanced secure data management environment, thereby helping to protect corporate and personal information.

Moreover, blockchain may ensure data confidentiality by using encryption techniques. Data stored on blockchain is encrypted, and only authorized users may access this data. In addition, even when data is transmitted over a blockchain network, the data is transmitted in an encrypted format, which may prevent data alteration or leakage en route. This encryption technique plays a crucial role in strengthening the security of sensitive data, including personal information.

Furthermore, blockchain may ensure data integrity through a consensus algorithm. All nodes participating in a blockchain network share a decentralized database, and upon the generation of each new data block, they validate and approve the generated data block. Thus, even when a single node maliciously attempts to alter data, a plurality of nodes may verify and reject the attempt, which may prevent the altered data from being reflected in the blockchain. This consensus process ensures data integrity and may prevent data forgery or alteration.

In addition, blockchain may enhance security through programming code known as smart contracts. Smart contracts execute based on pre-programmed conditions necessary for transactions or agreements, and this may enable transactions to be processed automatically and trustworthy agreements to be established without intermediaries. Such smart contracts ensure an automated transaction process devoid of human intervention, thereby enhancing data security.

Moreover, blockchain technology offers public transparency, which may enhance security. Because data stored on the blockchain is disclosed to all participants, everyone may access the history of data changes. This may help to rapidly detect and prevent data alteration or fraudulent activities. Moreover, blockchain maintains robust security against attacks through a consensus algorithm, thereby providing a more trustworthy data management environment.

Embodiments of the present disclosure provide a technology for storing and managing fault information about vehicles by utilizing blockchain technology.

According to an embodiment of the present disclosure, a system for managing fault information about vehicles based on blockchain is provided. The system may include a data storage unit configured to store at least one of fault information or a repair history of the vehicles, with interlinked blockchain tokens of vehicle controllers. The system may also include a first data transmission/reception (also referred to herein as “transmission-reception”) unit configured to transmit data to and receive data from, a main server configured to classify and manage the data by types of the vehicles, data pertaining to at least one of the fault information or the repair history of the vehicles, at preset periodic intervals, wherein the vehicle controllers each include a plurality of ECUs capable of storing the fault information in response to an occurrence of a fault, and a communication module capable of wireless communication with the main server.

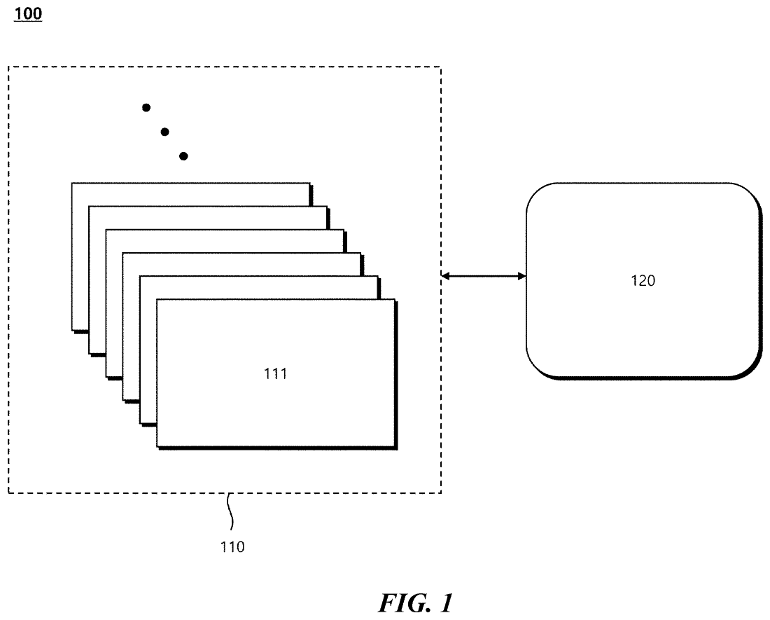

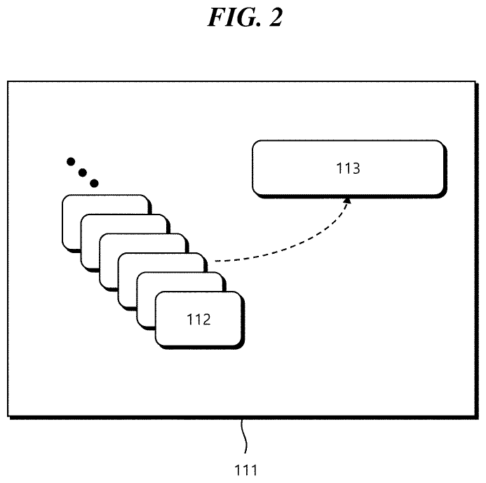

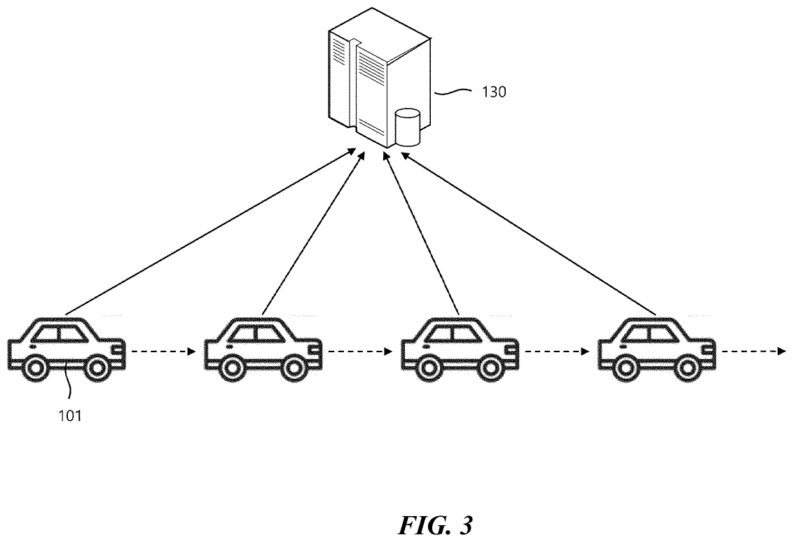

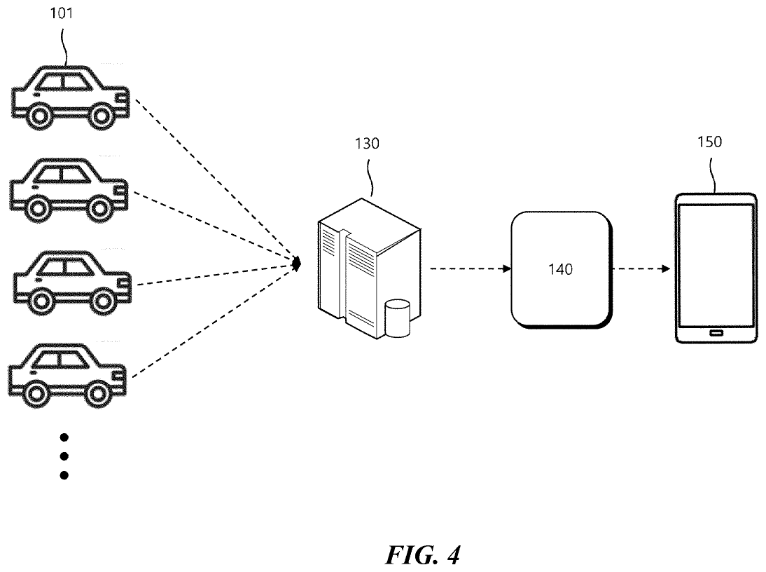

FIG. 1 is a diagram illustrating a vehicle fault information management system according to an embodiment. FIG. 2 is a diagram illustrating a vehicle controller according to an embodiment. FIG. 3 is a schematic diagram illustrating periodic transmission of fault data to a main server while a vehicle is driving, according to an embodiment. FIG. 4 is a schematic diagram illustrating management of collected fault data and transmission of the fault data to a user terminal, according to an embodiment.

Referring to FIGS. 1-4, a vehicle fault information management system 100 may include a data storage unit 110 and a first data transmission/reception unit 120.

The data storage unit 110 may store at least one of fault information or a repair history of vehicles 101, with interlinked blockchain tokens of vehicle controllers 111.

The blockchain tokens of vehicle controllers 111 may be issued when vehicles 101 are manufactured, and may store data pertaining to at least one of fault information or a repair history in corresponding blocks.

The vehicle controllers 111 may each include a plurality of ECUs 112 configured to store at least one of fault information or a repair history when a fault occurs in the vehicle 101, and a communication module 113 configured to wireless communicate with a main server 130.

A vehicle includes various electronic control devices, among which ECUs constitute an important part. ECUs are computerized devices used for controlling and monitoring various systems within a vehicle. Such ECU systems may include engines, transmissions, braking systems, airbags, acceleration control, fuel supply, and the like. ECUs play a crucial role in optimizing the performance of these systems and in maintaining vehicle safety and efficiency.

An ECU receives, as input, data collected from various sensors in a vehicle, and analyzes the data to generate an appropriate output. For example, an engine ECU may be used to optimize the performance of an engine by collecting data such as an engine temperature, an air pressure, or a fuel injection amount. A transmission ECU monitors the status of a transmission and controls gear shifts of the transmission to optimize the driving of the vehicle. A braking system ECU monitors the speed and braking pressure of the vehicle to generate an appropriate braking force. In this way, ECUs coordinate and control various systems in a vehicle, enabling safe and efficient driving.

When a fault occurs in a vehicle, an ECU is used to detect the fault and store related information. This process may involve various operations.

First, when a fault occurs, sensors in a corresponding system detect the fault and transmit information about the fault to an ECU. For example, when a fault occurs in an engine, engine sensors detect the fault and transmit fault information to an engine ECU.

Next, the ECU may analyze the fault information to determine an appropriate response. This may be performed in various ways, and for example, the ECU may activate a warning light or deactivate a specific function depending on the severity of the fault. In addition, the ECU may store the fault information, thereby allowing the vehicle's owner or a technician to check the fault information later.

As such, various types of fault information that may occur in vehicles may be stored in the plurality of ECUs 112, based on diagnostic communication logic included in each vehicle controller 111.

The first data transmission/reception unit 120 may transmit and receive data pertaining to at least one of fault information or a repair history of the vehicles 101 at preset periodic intervals, to and from the main server 130 that classifies and manages data stored in the data storage unit 110 according to the types of vehicles 101.

Data pertaining to at least one of fault information or a repair history may be periodically transmitted to the main server 130 when the corresponding vehicle 101 is driving. Based on this data, the data may be modeled to analyze fault patterns. In such cases, when a fault is determined to be chronic, preemptive measures may be taken, such as providing a wireless update or a notification to visit a vehicle inspection center.

The vehicle controller 111 may diagnose a controller failure by assessing various conditions according to criteria stipulated in regulations. The communication module 113 may obtain information regarding items confirmed as faults from inside vehicles at specific intervals, via diagnostic messages by using controller area network (CAN) or Ethernet. Various pieces of fault information may be aggregated and then transmitted, e.g., along with vehicle information, to the main server 130 via the first data transmission/reception unit 120. The main server 130 may manage the received data after grouping the data by vehicle model and may generate tokens based on data from each vehicle 101 to manage the data in a blockchain form.

By managing fault information in a blockchain form, a history of recorded failure information is maintained, and moreover, because it is a structure in which respective blockchains verify each other, data cannot be arbitrarily altered. In an embodiment, a blockchain token is structured such that it is formed with a hash value generated based on a unique number of the vehicle whenever the vehicle 101 is manufactured.

The stored information involves updating mutual hash information upon a request from the main server 130, and data validity is checked. The server may aggregate body data of the corresponding blocks and may extract trends pertaining to failure information about the corresponding vehicle model. For failure information deemed a critical issue, the manufacturer may take preemptive action.

Because fault information is managed in a blockchain form within each vehicle 101, the risk of corruption of data transmitted from the vehicle may be mitigated. In addition, vehicle information may be provided to a smart phone application via a user terminal 150 of the vehicle owner. In the related art, a driver is able to ascertain vehicle failure information solely via a malfunction indicator lamp (MIL) on the vehicle's cluster, and has to visit a repair shop or purchase separate vehicle scanner equipment to obtain detailed information. However, when the present disclosure is applied to a vehicle, it is possible to offer guidance on failure information without requiring the purchase of separate equipment.

The vehicle fault information management system 100 may further include a second data transmission/reception unit 140 configured to transmit data from the main server 130 to the user terminals 150 of the vehicles 101 so as to enable the users of the vehicles 101 to monitor data pertaining to at least one of fault information or a repair history of the vehicles 101.

As described above, the data storage unit 110 may ensure data security, as the blockchain tokens of the vehicle controllers 111 mutually assure data validity.

The blockchain token for the vehicle controller 111 may be issued via a hash value generated based on the unique number of the vehicle 101 when the vehicle 101 is manufactured.

In addition, the ECUs 112 may determine, according to preset criteria, whether data corresponds to fault information, and manage the data as fault memory.

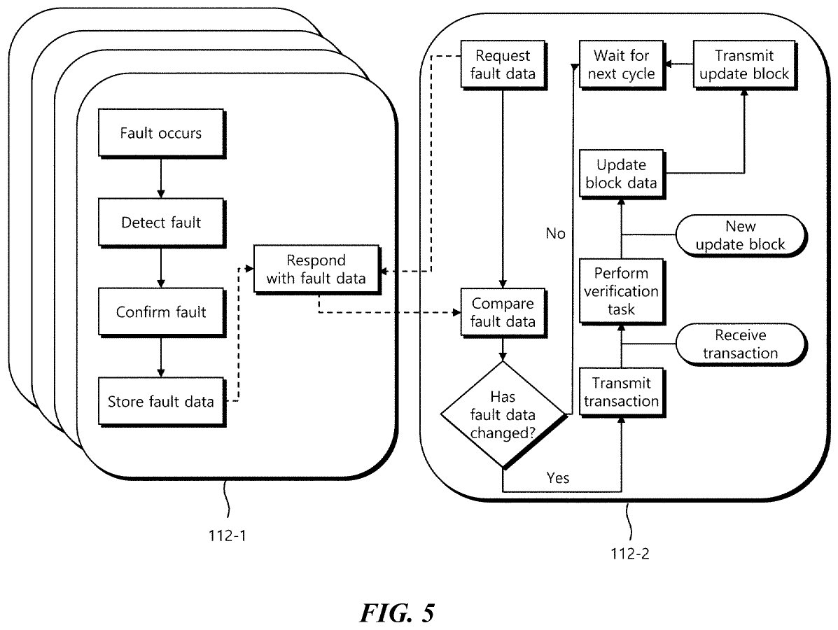

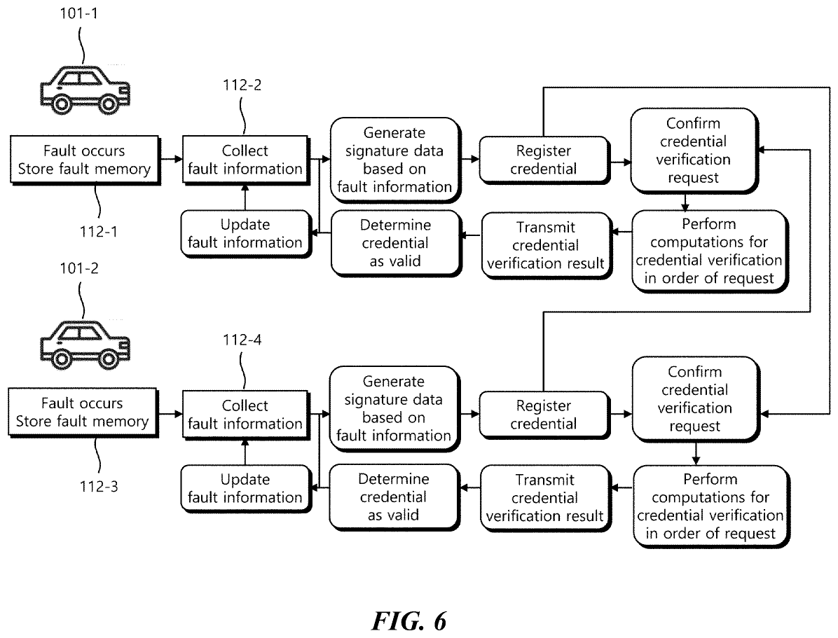

FIG. 5 is a schematic diagram illustrating a process in which an ECU confirms and stores fault data, according to an embodiment. FIG. 6 is a schematic diagram illustrating a process in which a plurality of vehicles perform computations for a credential verification request regarding fault information to determine the validity of the fault information and perform updates, according to an embodiment.

FIGS. 5 and 6 illustrate a process in which an ECU confirms and stores fault data and a process in which a plurality of vehicles determine the validity of fault information.

In an embodiment, the vehicle controllers 111 may determine errors according to specifications defined for the respective vehicle controllers 111. When an error has occurred and is registered as a fault, information that the vehicle controller 111 is required to manage for each error may be managed as fault memory. For diagnostic trouble codes (DTCs) that the vehicle controllers 111 are required to manage, fault memory may be managed with a standardized structure specific to each DTC. The vehicle controllers 111 may assess faults for each fault item, and when a fault is confirmed based on satisfying (e.g., exceeding) a fault determination criterion for the corresponding item, the vehicle controllers 111 may store the fault information along with relevant situational information.

While the vehicles 101 are driving or stationary, the respective vehicle controllers 111 may diagnose and store fault information while executing their individual cycles. In an embodiment, in the communication module 113, that is capable of wireless communication with a server, fault monitoring is performed. The communication module 113 may collect fault information at specific intervals by utilizing a Unified Diagnostic Services (UDS) diagnostic protocol.

Via CAN bus or Ethernet, diagnostic information from each vehicle controller 111 may be received from within the vehicle by utilizing the UDS diagnostic protocol. The collected data may initiate calculation of a hash value for a data block of the current vehicle based on the unique number of the corresponding vehicle and current fault information. When the calculation of the hash value for the block corresponding to the current vehicle is completed, credential verification may be requested from the main server 130 and other vehicles 101. When the credential verification for the corresponding block is completed, including by the main server, all vehicles 101 and the main server 130 may update their respective blocks.

Data transmitted from the vehicles 101 to the main server 130 may generate transactions and may be managed as tokens. The tokens may be managed after being grouped by vehicle model, and these pieces of data may be collected to analyze fault diagnosis trends. As such, as fault data accumulates, fault situation data may be aggregated with respect to frequently occurring fault situations, so as to analyze structural faults in vehicles and the like. In addition, such data may also yield temporal and economic benefits during development by serving as a reference for designing future mass-produced vehicle systems.

By leveraging these aspects, accidents stemming from design and structural faults in vehicles may be preemptively prevented, and additional costs arising from subsequent quality issues may be reduced. Furthermore, consumers may easily access failure information about their vehicles online.

In an embodiment, the first data transmission/reception unit 120 may transmit fault memory data, along with information about the vehicles 101, to the main server 130 by using a wireless communication network.

When a vehicle 101 is manufactured or when data pertaining to at least one of new fault information or repair history is generated, the main server 130 may request the blockchain tokens of the vehicle controllers 111 to update the hash information.

Upon the request to update the hash information, the blockchain tokens of the vehicle controllers 111 may request update credential verification from other vehicles that are connected via a wireless communication network through the main server 130.

When a validity assessment result, computed in response to such an update credential verification request, is determined to satisfy a preset criterion (e.g., be 80% or higher), credential verification may be completed and the blockchain tokens of the vehicle controllers 111 may perform an update of the hash information.

The execution of an update for which credential verification has been completed may be given priority (e.g., may be performed with the highest priority) by the blockchain tokens of the vehicle controllers 111.

In an embodiment, multiple wirelessly connected vehicle models perform computations for a credential verification request for which an update is being performed. First, results may be received sequentially from controllers for which proof-of-work has been completed, and when the proportion of results deemed valid satisfies a preset criterion (e.g., exceeds 80%), a fault information update may be requested for all vehicle models. This request may be treated as the highest priority task, interrupting any ongoing computations so as to perform updates on the blocks for current failure information. Credential verification requests may be accumulated in a queue for each vehicle, and computations may be performed sequentially, with the results subsequently shared. Through this process of mutual credential verification, external data contamination and the like may be prevented, and it may become easier to analyze the overall trend of failure history from an external perspective.

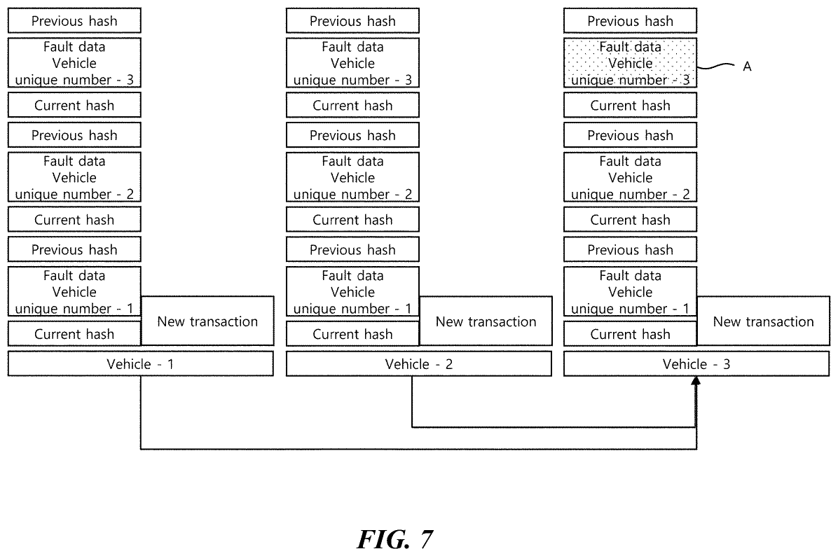

FIG. 7 is a schematic diagram illustrating a fault information management process that addresses malicious data alteration, according to an embodiment.

FIG. 7 illustrates a process for securely managing fault information in the event of malicious data alteration, according to an embodiment.

Referring to FIG. 7, assume that in one vehicle, failure data of the vehicle has been manipulated (A) due to malicious hacking. Because obtaining a private key during a data manipulation process is difficult, updating all blocks by initiating a blockchain transaction based on the altered data is impossible. Even when an attempt is made to perform an update based on altered data from the vehicle, other vehicle controllers possess the pre-alteration data, and consequently, the maliciously altered data (A) is discarded during a credential verification process. Because data is stored in this distributed manner, normal recovery is possible even when data in a single vehicle is maliciously altered at some point.

Next, a blockchain-based vehicle fault information management apparatus according to another embodiment is described in detail.

According to an embodiment, there may be provided an apparatus for managing fault information about vehicles based on blockchain, the apparatus including: a data storage module configured to store at least one of fault information or a repair history of the vehicles, with interlinked blockchain tokens of vehicle controllers; a first data transmission/reception module configured to transmit and receive, to and from a main server configured to classify and manage the data by types of the vehicles, data pertaining to at least one of the fault information or the repair history of the vehicles, at preset periodic intervals; and a second data transmission/reception module configured to transmit the data from the main server to terminals of users of the vehicles so as to enable the users of the vehicles to monitor data pertaining to at least one of the fault information or the repair history, wherein the vehicle controllers each include a plurality of ECUs capable of storing the fault information in response to an occurrence of a fault, and a communication module capable of wireless communication with the main server.

A data storage module included in the data storage unit 110 may store at least one of fault information or a repair history of the vehicles 101, with interlinked blockchain tokens of the vehicle controllers 111.

The blockchain tokens of vehicle controllers 111 may be issued when the vehicles 101 are manufactured, and may store data pertaining to at least one of fault information or a repair history in corresponding blocks.

The vehicle controllers 111 may each include a plurality of ECUs 112 capable of storing at least one of fault information or a repair history when a fault occurs in the vehicle 101, and a communication module 113 capable of wireless communication with the main server 130.

Various types of fault information that may occur in vehicles may be stored in the plurality of ECUs 112, based on diagnostic communication logic included in each vehicle controller 111.

The first data transmission/reception unit 120 may transmit and receive data pertaining to at least one of fault information or a repair history of the vehicles 101 at preset periodic intervals, to and from the main server 130 that classifies and manages data stored in the data storage unit 110 according to the types of vehicles 101.

Data pertaining to at least one of fault information or a repair history may be periodically transmitted to the main server 130 when the corresponding vehicle 101 is driving, and based on this data, the data may be modeled to analyze fault patterns. In such cases, when a fault is determined to be chronic, preemptive measures may be taken, such as providing a wireless update or a notification to visit a vehicle inspection center.

The vehicle controller 111 may diagnose a controller failure by assessing various conditions according to criteria stipulated in regulations. The communication module 113 may obtain information regarding items confirmed as faults from inside vehicles at specific intervals, via diagnostic messages by using CAN or Ethernet. Various pieces of fault information may be aggregated and then transmitted, e.g., along with vehicle information, to the main server 130 via a first data transmission/reception module that is included in the first data transmission/reception unit 120. The main server 130 may manage the received data after grouping the data by vehicle model and may generate tokens based on data from each vehicle 101 to manage the data in a blockchain form.

By managing fault information in a blockchain form, a history of recorded failure information is maintained, and moreover, because it is a structure in which respective blockchains verify each other, data cannot be arbitrarily altered. In an embodiment, a blockchain token is structured such that it is formed with a hash value generated based on a unique number of the vehicle whenever the vehicle 101 is manufactured.

The stored information involves updating mutual hash information upon a request from the main server 130, and data validity is checked. The server 130 may aggregate body data of the corresponding blocks and may extract trends pertaining to failure information about the corresponding vehicle model. For failure information deemed a critical issue, the manufacturer may take preemptive action.

Because fault information is managed in a blockchain form within each vehicle 101, the risk of corruption of data transmitted from the vehicle may be mitigated. In addition, vehicle information may be provided to a smart phone application via the user terminal 150 of the vehicle owner. In the related art, a driver is able to ascertain vehicle failure information solely via an MIL on the vehicle's cluster, and has to visit a repair shop or purchase separate vehicle scanner equipment to obtain detailed information. However, when embodiments of the present disclosure are applied to a vehicle, it is possible to offer guidance on failure information without requiring the purchase of separate equipment.

The vehicle fault information management system 100 may further include the second data transmission/reception unit 140 including a second data transmission/reception module configured to transmit data from the main server 130 to the user terminals 150 of the vehicles 101 so as to enable the users of the vehicles 101 to monitor data pertaining to at least one of fault information or a repair history of the vehicles 101.

As described above, the data storage unit 110 may ensure data security, as the blockchain tokens of the vehicle controllers 111 mutually assure data validity.

The blockchain token for the vehicle controller 111 may be issued via a hash value generated based on the unique number of the vehicle 101 when the vehicle 101 is manufactured.

In addition, the ECUs 112 may determine, according to preset criteria, whether data corresponds to fault information, and manage the data as fault memory.

Next, a process in which an ECU confirms and stores fault data, and a process in which a plurality of vehicles determine the validity of fault information, according to an embodiment, are described.

In an embodiment, the vehicle controllers 111 determine errors according to specifications defined for the respective vehicle controllers 111. When an error has occurred and is registered as a fault, information that the vehicle controller 111 is required to manage for each error may be managed as fault memory. For DTCs that the vehicle controllers 111 are required to manage, fault memory may be managed with a standardized structure specific to each DTC. The vehicle controllers 111 may assess faults for each fault item, and when a fault is confirmed as satisfying (e.g., exceeding) a fault determination criterion for the corresponding item, the controllers 111 may store the fault information along with relevant situational information.

While the vehicles 101 are driving or stationary, the respective vehicle controllers 111 may diagnose and store fault information while executing their individual cycles. In an embodiment, in the communication module 113, which is capable of wireless communication with a server, fault monitoring is performed. The communication module 113 may collect fault information at specific intervals by utilizing a UDS diagnostic protocol.

Via CAN bus or Ethernet, diagnostic information from each vehicle controller 111 may be received from within the vehicle by utilizing the UDS diagnostic protocol. The collected data initiates calculation of a hash value for a data block of the current vehicle based on the unique number of the corresponding vehicle and current fault information. When the calculation of the hash value for the block corresponding to the current vehicle is completed, credential verification is requested from the main server 130 and other vehicles 101. When the credential verification for the corresponding block is completed, including by the main server, all vehicles 101 and the main server 130 update their respective blocks.

Data transmitted from the vehicles 101 to the main server 130 may generate transactions and may be managed as tokens. The tokens may be managed after being grouped by vehicle model, and these pieces of data are collected to analyze fault diagnosis trends. As such, as fault data accumulates, fault situation data may be aggregated with respect to frequently occurring fault situations, so as to analyze structural faults in vehicles and the like. In addition, such data may also yield temporal and economic benefits during development by serving as a reference for designing future mass-produced vehicle systems.

By leveraging these aspects, accidents stemming from design and structural faults in vehicles may be preemptively prevented, and additional costs arising from subsequent quality issues may be reduced. Furthermore, consumers may easily access failure information about their vehicles online.

In an embodiment, the first data transmission/reception unit 120 including the first data transmission/reception module may transmit fault memory data, along with information about the vehicles 101, to the main server 130 by using a wireless communication network.

When a vehicle 101 is manufactured or when data pertaining to at least one of new fault information or repair history is generated, the main server 130 may request the blockchain tokens of the vehicle controllers 111 to update the hash information.

Upon the request to update the hash information, the blockchain tokens of the vehicle controllers 111 may request update credential verification from other vehicles that are connected via a wireless communication network through the main server 130.

When a validity assessment result, which is computed in response to such an update credential verification request, is determined to satisfy a preset criterion (e.g., be 80% or higher), credential verification is completed and the blockchain tokens of the vehicle controllers 111 may perform an update of the hash information.

The execution of an update for which credential verification has been completed may be given priority (e.g., may be performed with the highest priority) by the blockchain tokens of the vehicle controllers 111.

In an embodiment, multiple wirelessly connected vehicle models perform computations for a credential verification request for which an update is being performed. First, results are received sequentially from controllers for which proof-of-work has been completed, and when the proportion of results deemed valid satisfies a preset criterion (e.g., exceeds 80%), a fault information update may be requested for all vehicle models. This request may be treated as the highest priority task, interrupting any ongoing computations so as to perform updates on the blocks for current failure information. Credential verification requests may be accumulated in a queue for each vehicle, and computations may be performed sequentially, with the results subsequently shared. Through this process of mutual credential verification, external data contamination and the like may be prevented, and it becomes easier to analyze the overall trend of failure history from an external perspective.

The vehicle fault information management apparatus may further include a second data transmission/reception module configured to transmit data from the main server 130 to the user terminals 150 of the vehicles so as to enable the users of the vehicles 101 to monitor data pertaining to at least one of fault information or a repair history.

The data storage module may ensure data security, as the blockchain tokens of the vehicle controllers 111 mutually assure data validity.

The first data transmission/reception module may collect data pertaining to at least one of fault information or a repair history of the vehicles by utilizing a UDS diagnostic protocol.

Next, a blockchain-based vehicle fault information management method according to yet another embodiment is described in detail.

According to an embodiment, there may be provided a method of managing fault information about vehicles based on blockchain, the method including: a data storage operation of storing at least one of fault information or a repair history of the vehicles, in interlinked blockchain tokens of vehicle controllers; a first data transmission/reception operation of transmitting and receiving data pertaining to at least one of the fault information or the repair history of the vehicles at preset periodic intervals; and a data management operation of managing the data by classifying the data in a main server according to types of the vehicles and updating the data with new information, wherein the vehicle controllers each include a plurality of ECUs capable of storing the fault information in response to an occurrence of a fault, and a communication module capable of wireless communication with the main server.

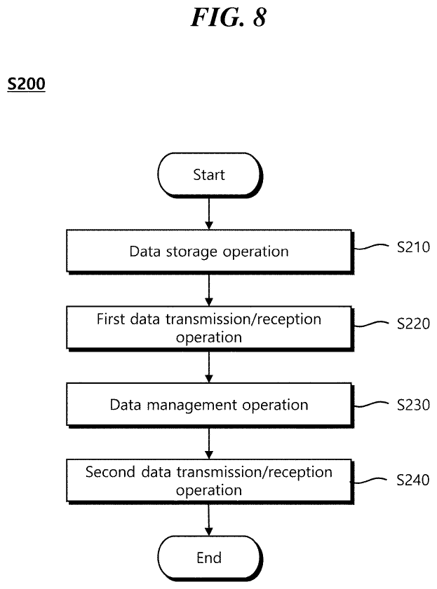

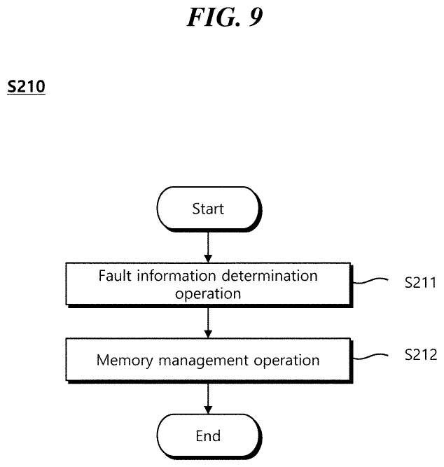

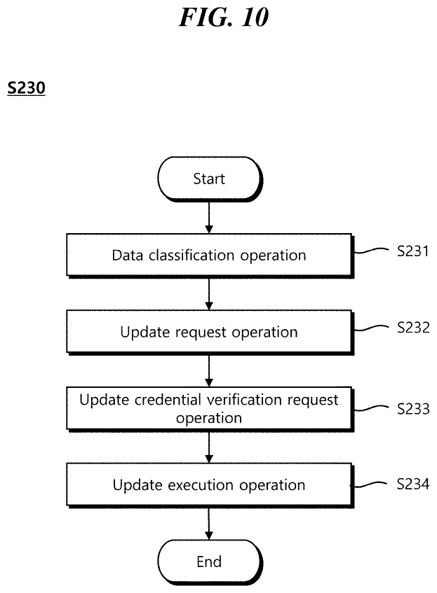

FIG. 8 is a flowchart illustrating a vehicle fault information management method according to an embodiment. FIG. 9 is a flowchart illustrating a data storage operation according to an embodiment. FIG. 10 is a flowchart illustrating a data management operation according to an embodiment.

Referring to FIGS. 8-10, a vehicle fault information management method S200 may include a data storage operation S210, a first data transmission/reception operation S220, and a data management operation S230. In addition, the vehicle fault information management method S200 may further include a second data transmission/reception operation S240.

In the data storage operation S210, interlinked blockchain tokens of the vehicle controllers 111 may store at least one of fault information or a repair history of the vehicles 101.

In an embodiment, the data storage operation S210 may include a fault information determination operation S211 in which the ECU 112 determines, according to preset criteria, whether data corresponds to fault information, and a memory management operation S212 in which data corresponding to fault information is managed as fault memory.

While the vehicle 101 is driving, the ECU 112 may determine whether data corresponds to fault information, and store the data.

In the first data transmission/reception operation S220, data pertaining to at least one of fault information or a repair history of vehicles 101 may be transmitted and received at preset periodic intervals.

In the data management operation S230, data may be managed by classifying the data in the main server 130 according to the types of vehicles 101, and updating the data with new information.

In an embodiment, the data management operation S230 may include a data classification operation S231 of classifying data received by the main server 130 according to the types of vehicles 101, an update request operation S232 of, when a vehicle 101 is manufactured or when data pertaining to at least one of new fault information or repair history is generated, requesting the blockchain tokens of vehicle controllers 111 to perform an update of hash information, an update credential verification request operation S233 of, upon the request to update the hash information, requesting, by the blockchain tokens of vehicle controllers 111, update credential verification from other vehicles that are connected via a wireless communication network through the main server 130, and an update execution operation S234 of, upon completion of update credential verification, performing, by the blockchain tokens of vehicle controllers 111, an update of the hash information.

In addition, in the second data transmission/reception operation S240, data may be transmitted from the main server 130 to the user terminals 150 of the vehicles 101 so as to enable the users of the vehicles 101 to monitor data pertaining to at least one of fault information or a repair history.

The vehicle controllers 111 may determine errors according to specifications defined for the respective vehicle controllers 111. When an error has occurred and is registered as a fault, information that the vehicle controller 111 is required to manage for each error may be managed as fault memory. For DTCs that the vehicle controllers 111 are required to manage, fault memory may be managed with a standardized structure specific to each DTC. The vehicle controllers 111 may assess faults for each fault item, and when a fault is confirmed as it exceeds a fault determination criterion for the corresponding item, the controllers 111 may store the fault information along with relevant situational information.

While the vehicles 101 are driving or stationary, the respective vehicle controllers 111 may diagnose and store fault information while executing their individual cycles. In an embodiment, in the communication module 113, which is capable of wireless communication with a server, fault monitoring is performed. The communication module 113 collects fault information at specific intervals by utilizing a UDS diagnostic protocol.

Via CAN bus or Ethernet, diagnostic information from each vehicle controller 111 may be received from within the vehicle by utilizing the UDS diagnostic protocol. The collected data initiates calculation of a hash value for a data block of the current vehicle based on the unique number of the corresponding vehicle and current fault information. When the calculation of the hash value for the block corresponding to the current vehicle is completed, credential verification is requested from the main server 130 and other vehicles 101. When the credential verification for the corresponding block is completed, including by the main server, all vehicles 101 and the main server 130 update their respective blocks.

Data transmitted from the vehicles 101 to the main server 130 may generate transactions and may be managed as tokens. The tokens may be managed after being grouped by vehicle model, and these pieces of data may be collected to analyze fault diagnosis trends. As such, as fault data accumulates, fault situation data may be aggregated with respect to frequently occurring fault situations, so as to analyze structural faults in vehicles and the like. In addition, such data may also yield temporal and economic benefits during development by serving as a reference for designing future mass-produced vehicle systems.

By leveraging these aspects, accidents stemming from design and structural faults in vehicles may be preemptively prevented, and additional costs arising from subsequent quality issues may be reduced. Furthermore, consumers may easily access failure information about their vehicles online.

Update credential verification may be completed when a validity assessment result, which is computed in response to an update credential verification request, is determined to satisfy a preset criterion (e.g., be 80% or higher).

In addition, the execution of an update for which credential verification has been completed may be given priority (e.g., may be performed with the highest priority) by the blockchain tokens of the vehicle controllers.

In an embodiment, multiple wirelessly connected vehicle models perform computations for a credential verification request for which an update is being performed. First, results are received sequentially from controllers for which proof-of-work has been completed, and when the proportion of results deemed valid satisfies a preset criterion (e.g., exceeds 80%), a fault information update may be requested for all vehicle models. This request may be treated as the highest priority task, interrupting any ongoing computations so as to perform updates on the blocks for current failure information. Credential verification requests may be accumulated in a queue for each vehicle, and computations may be performed sequentially, with the results subsequently shared. Through this process of mutual credential verification, external data contamination and the like may be prevented, and it becomes easier to analyze the overall trend of failure history from an external perspective.

The terms such as “include,” “comprise,” or “have” described above mean that the corresponding component may be inherent as long as there is no particular opposing recitation, and thus, it should be interpreted that other components may be further included rather than excluded. All terms used herein, including technical and scientific terms, have the same meaning as commonly understood by those having ordinary skill in the art, unless defined otherwise. Terms, such as those defined in commonly used dictionaries, should be interpreted as having a meaning that is consistent with their meaning in the context of the relevant art and the present disclosure, and should not be interpreted in an idealized or overly formal sense unless expressly so defined herein.

The above description merely explains the technical idea of the present disclosure and the present disclosure may be changed and modified in various ways by those having ordinary skill in the art without departing from the scope of the present disclosure. Accordingly, the embodiments described herein are provided not to limit, but to merely explain the technical idea of the present disclosure, and the technical idea of the present disclosure is not limited by the embodiments. The scope of the present disclosure should be construed by the following claims, and all technical ideas within the equivalent scope should be construed as being included in the scope of the present disclosure.

What is claimed is:

1. A system for managing fault information about vehicles based on blockchain, the system comprising:
a data storage unit configured to store at least one of fault information or a repair history of the vehicles, with interlinked blockchain tokens of vehicle controllers; and
a first data transmission-reception unit configured to transmit and receive, to and from a main server, data pertaining to at least one of the fault information or the repair history of the vehicles, at preset periodic intervals, wherein the main server is configured to classify and manage the data by types of the vehicles,
wherein the vehicle controllers each includes:
a plurality of electronic control units (ECUs) configured to store the fault information in response to an occurrence of a fault, and
a communication module configured to wirelessly communicate with the main server.

2. The system of claim 1, further comprising a second data transmission-reception unit configured to transmit the data from the main server to user terminals of the vehicles to enable users of the vehicles to monitor the data pertaining to at least one of the fault information or the repair history.

3. The system of claim 1, wherein, in the data storage unit, the blockchain tokens of the vehicle controllers mutually assure data validity to ensure data security.

4. The system of claim 1, wherein the blockchain tokens of the vehicle controllers are issued via respective hash values that are generated based on unique numbers of the vehicles at a time of manufacture of the vehicles are manufactured.

5. The system of claim 1, wherein the ECUs are configured to:
determine, according to preset criteria, whether data corresponds to the fault information; and
manage the data that corresponds to the fault information as fault memory.

6. The system of claim 5, wherein the first data transmission/reception unit is further configured to transmit fault memory data, along with vehicle information, to the main server by using a wireless communication network.

7. The system of claim 1, wherein the main server is further configured to, in response to a vehicle being manufactured or in response to data pertaining to at least one of new fault information or repair history being generated, request the blockchain tokens of the vehicle controllers to update hash information.

8. The system of claim 7, wherein the blockchain tokens of the vehicle controllers are configured to, in response to an occurrence of a request to update the hash information, request update credential verification from other vehicles that are connected via a wireless communication network through the main server.

9. The system of claim 8, wherein, in response to a validity assessment result, computed in response to the update credential verification request, being determined to satisfy a preset criterion, credential verification is completed, and the blockchain tokens of the vehicle controllers perform an update of the hash information.

10. The system of claim 9, wherein execution of the update for which the credential verification has been completed is given priority by the blockchain tokens of the vehicle controllers.

11. An apparatus for managing fault information about vehicles based on blockchain, the apparatus comprising:
a data storage module configured to store at least one of fault information or a repair history of the vehicles, with interlinked blockchain tokens of vehicle controllers;
a first data transmission-reception module configured to transmit and receive, to and from a main server, data pertaining to at least one of the fault information or the repair history of the vehicles, at preset periodic intervals, wherein the main server is configured to classify and manage the data by types of the vehicles; and
a second data transmission-reception module configured to transmit the data from the main server to terminals of users of the vehicles to enable the users of the vehicles to monitor the data pertaining to the at least one of the fault information or the repair history,
wherein the vehicle controllers each includes:
a plurality of electronic control units (ECUs) configured to store the fault information in response to an occurrence of a fault, and
a communication module configured to wireless communicate with the main server.

12. The apparatus of claim 11, wherein, in the data storage module, the blockchain tokens of the vehicle controllers mutually assure data validity to ensure data security.

13. The apparatus of claim 11, wherein the first data transmission-reception module is further configured to collect the data pertaining to the at least one of the fault information or the repair history of the vehicles by utilizing a Unified Diagnostic Services (UDS) diagnostic protocol.

14. A method of managing fault information about vehicles based on blockchain, the method comprising:
a data storage operation of storing at least one of fault information or a repair history of the vehicles, in interlinked blockchain tokens of vehicle controllers;
a first data transmission-reception operation of transmitting and receiving data pertaining to at least one of the fault information or the repair history of the vehicles at preset periodic intervals; and
a data management operation of managing the data by classifying the data in a main server according to types of the vehicles and updating the data with new information,
wherein the vehicle controllers each includes:
a plurality of electronic control units (ECUs) capable of storing the fault information in response to an occurrence of a fault, and
a communication module configured to wirelessly communicate with the main server.

15. The method of claim 14, further comprising a second data transmission-reception operation of transmitting the data from the main server to terminals of users of the vehicles to enable the users of the vehicles to monitor the data pertaining to the at least one of the fault information or the repair history.

16. The method of claim 14, wherein the data storage operation includes:
a fault information determination operation of determining, by the ECUs, whether data corresponds to the fault information, according to preset criteria; and
a fault memory management operation of managing data corresponding to the fault information as fault memory.

17. The method of claim 16, wherein the ECUs are configured to, while the vehicles are driving, determine whether data corresponds to the fault information, and store the data.

18. The method of claim 14, wherein the data management operation includes:
a data classification operation of classifying the data received by the main server according to the types of the vehicles;
an update request operation of, in response to a vehicle being manufactured or in response to data pertaining to at least one of new fault information or repair history being generated, requesting the blockchain tokens of the vehicle controllers to update hash information;
an update credential verification request operation of, in response to an occurrence of a request to update the hash information, requesting, by the blockchain tokens of the vehicle controllers, update credential verification from other vehicles that are connected via a wireless communication network through the main server; and
an update execution operation of, in response to completion of update credential verification, performing, by the blockchain tokens of the vehicle controllers, an update of the hash information.

19. The method of claim 18, wherein the update credential verification is completed in response to a validity assessment result, computed in response to an update credential verification request, being determined to satisfy a preset criterion.

20. The method of claim 19, wherein execution of the update for which the credential verification has been completed is given priority by the blockchain tokens of the vehicle controllers.
